(19) United States
(12) Patent Application Publication
(10) Pub. No.: US 2022/0383033 A1
(43) Pub. Date: Dec. 1, 2022

(54) IMPUTATION-BASED SAMPLING RATE ADJUSTMENT OF PARALLEL DATA STREAMS

(71) Applicant: Oracle International Corporation, Redwoood Shores, CA (US)

(72) Inventors: John Frederick Courtney, Benton, CA (US); Guang Chao Wang, San Diego, CA (US); Matthew Torin Gerdes, Oakland, CA (US); Kenny C. Gross, Escondido, CA (US)

(73) Assignee: Oracle International Corporation, Redwood Shores, CA (US)

(21) Appl. No.: 17/303,427

(22) Filed: May 28, 2021

(51) Int. Cl. G06K 9/62

(52) U.S. Cl. CPC G06K 9/623; G06K 9/6256; G06K 9/6244

(57) ABSTRACT

Techniques for generating imputation-based, uniformly sampled parallel streams of time-series data are disclosed. A system divides into two subsets a dataset made up of multiple data streams. The data streams include interpolated data. The system trains one data correlation model using one subset of the data and applies the trained model to the other subset. The system replaces the interpolated values in the other subset with estimated values generated by the model. The system trains another data correlation model using the revised subset. The system applies the new model to the initial subset to generate estimated values for the initial subset. The system replaces the interpolated values in the initial subset with the estimated values. The system repeats the process of training data correlation models and revising previously-interpolated data points in the subsets of data until a predetermined iteration threshold is met.

### TECHNICAL FIELD

The present disclosure relates to adjusting the sampling rates of parallel data streams with imputation-based data points. In particular, the present disclosure relates to iteratively replacing interpolation-based data points in parallel data streams with imputation-based data points.

### BACKGROUND

The expansion of Internet-of-Things (IoT) applications has resulted in systems that are monitored simultaneously by multiple different streams of data generated by multiple different sensors. Frequently, sensors have different sampling rates. In addition, even when sensor outputs are generated based on synchronized clock signals, the clock signal frequencies fluctuate based on an operating system, hardware, and environmental conditions. Data processing systems attempt to process received data streams to have uniform sampling rates by up-sampling, down-sampling, or performing some combination of up-sampling and down-sampling. Typically, up-sampling or down-sampling are performed by an interpolation-based process in which the data processing system adds data points to a data stream based on the values of surrounding data points. However, interpolation-based sampling adjustment does not capture sensor value variations that may not be apparent by considering only surrounding data values. As a result, interpolated data has little value for prognostication applications since interpolated data does not capture events in a system that do not follow the trends of surrounding measured data points.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates a system in accordance with one or more embodiments;

FIGS. 2A and 2B illustrate an example set of operations for performing imputation-based up-sampling of parallel data streams in accordance with one or more embodiments;

FIG. 3 illustrates an example embodiment in accordance with one or more embodiments; and

FIG. 4 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.

1. GENERAL OVERVIEW

2. SYSTEM ARCHITECTURE

3. GENERATING IMPUTATION-BASED TIME-SERIES DATA

4. EXAMPLE EMBODIMENT

5. COMPUTER NETWORKS AND CLOUD NETWORKS

6. MISCELLANEOUS; EXTENSIONS

7. HARDWARE OVERVIEW

### 1. General Overview

A data processing system may receive multiple, parallel data streams of sensor data monitoring one or more systems or processes. Two streams of sensor data may have different sampling rates and may be unsynchronized relative to each other. The system generates a data set in which the two streams of sensor data have a uniform sampling rate by interpolating data points into one or both of the data streams. The data streams including interpolated data points are provided to a data correlation model. The data correlation model identifies correlations between the data streams in the dataset. For example, the data correlation model may identify a pattern that when one data stream reaches a threshold value, another data stream tends to respond by changing to a particular value within a certain period of time. Based on the identified correlations, the model imputes estimated values of the data points in the dataset. The data processing system replaces the interpolated data points in the dataset with the imputed data points. The resulting dataset, having the interpolation-based data points replaced by the imputation-based data points, more accurately reflects actual conditions in the system monitored by the data sources. For example, since the imputation-based data is based on correlations among data points in the different data streams, the imputation-based data is able to predict outlier values and other types of degradation signatures. As a result, unlike the interpolated data points, the imputed data points may be used in prognostication-type applications.

In one or more embodiments, providing data streams, including interpolated data values, to a data correlation model to generate an imputation-based data set includes dividing a set of data into two subsets. The set of data is a set of time-series data of multiple, parallel data streams. The data streams have a uniform sampling rate as a result of interpolation-based up-sampling or down-sampling. The system trains a data correlation model using a first subset of the data set. The system applies the trained model to a second subset of the data set to generate imputation-based estimated data values for the second subset. The system replaces the interpolation-generated data values in the second subset with the imputation-based estimated data values generated by the imputation-based model, resulting in a revised second subset. The system (a) trains another data correlation model using the revised second subset, (b) applies the new data correlation model to the first subset to generate imputed estimated values for the first subset, and (c) replaces the interpolation-based data values in the first subset with imputation-based estimated data values generated by the newly-trained data correlation model.

In one or more embodiments, the system concatenates the revised first subset and the revised second subset to generate a revised full set of data in which any interpolated values have been replaced by imputed values from a data correlation model. The system repeats the process of (a) dividing the revised data set into two subsets, (b) training data a correlation model using one subset, and (c) applying the trained data correlation model to the other subset to generate revised subsets, for the two subsets. With each iteration, the values from the initial dataset that were initially generated by an interpolation-based process are iteratively updated based on the imputed estimated values generated by the data correlation models. Repeating the process further improves the accuracy of the imputed data values. In one embodiment, the process is performed at least three times, and at most five times.

In one or more embodiments, the system identifies a process that utilizes the data set. The process may include, for example, a data analysis process, a data display process, or a system control process. The system replaces the original data set, including parallel streams of un-synchronized time-series data having different sampling rates, with the revised data set, including the synchronized parallel streams of time series data having imputed values to achieve a uniform sampling rate among the streams of data.

In one or more embodiments, the system divides the data set into the first and second subsets according to a point in time. The first subset may include a portion of the time series data from a first point in time to a second point in time later than the first point in time. The second subset may include a portion of the time series data from the second point in time to a third point in time later than the second point in time.

One or more embodiments described in this Specification and/or recited in the claims may not be included in this General Overview section.

### 2. System Architecture

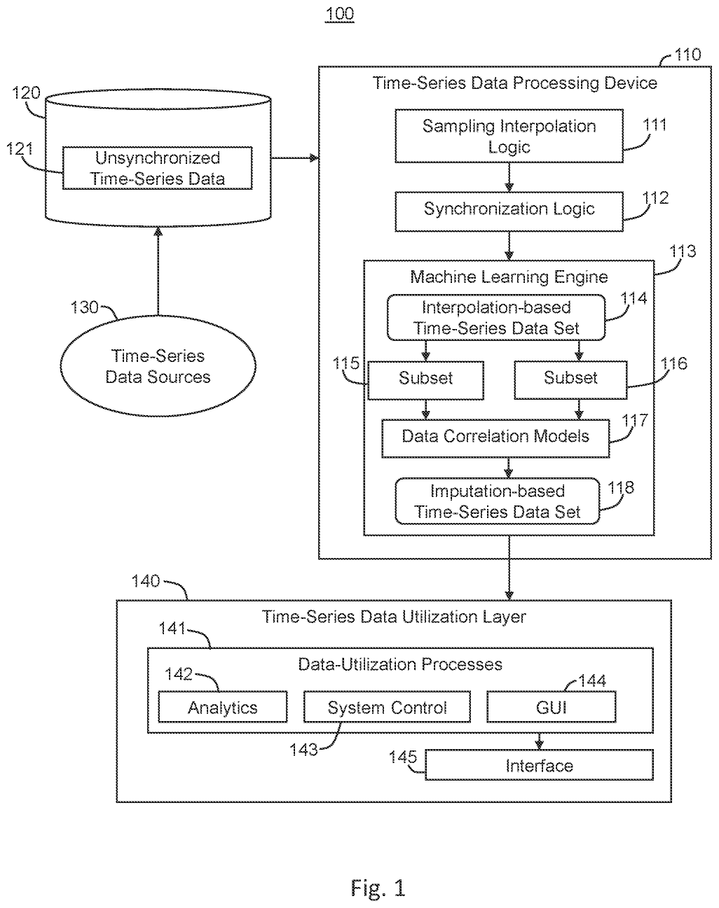

FIG. 1 illustrates a system 100 in accordance with one or more embodiments. As illustrated in FIG. 1, system 100 includes a time-series data processing device 110, a data repository 120, a plurality of time-series data sources 130, and a time-series data utilization layer 140.

The time-series data processing device 110 processes unsynchronized time-series data 121 obtained from the time-series data sources 130. In one embodiment, the unsynchronized time-series data 121 is stored or binned in the data repository 120 prior to being accessed by the time-series data processing device 110. In one or more embodiments, the data repository 120 is any type of storage unit and/or device (e.g., a file system, database, collection of tables, or any other storage mechanism) for storing data. Further, the data repository 120 may include multiple different storage units and/or devices. The multiple different storage units and/or devices may or may not be of the same type or located at the same physical site. Further, a data repository 120 may be implemented or may execute on the same computing system as the time-series data processing device 110. Alternatively or additionally, a data repository 120 may be implemented or executed on a computing system separate from the time-series data processing device 110. The data repository 120 may be communicatively coupled to the time-series data processing device 110 via a direct connection or via a network.

Information describing the unsynchronized time-series data 121 may be implemented across any components within the system 100. However, this information is illustrated within the data repository 120 for purposes of clarity and explanation.

In one or more embodiments, the time-series data sources 130 include multiple sensors. For example, a single facility —such as a plant or factory, may have many sensors monitoring processes in the facility. The many sensors generate time-series data, each measuring a particular attribute in the facility. The time-series data processing device 110 may receive the time-series data and process the data to be used by one or more processes or devices of the time-series data utilization layer 140.

The time-series data processing device 110 includes sampling interpolation logic 111. The sampling interpolation logic 111 identifies differences in sampling rates among the time-series data streams and adjusts the sampling rates to generate time-series data streams having uniform sampling rates. The sampling interpolation logic 111 adjusts the sampling rates using interpolation. For example, the sampling interpolation logic 111 may compare two data streams. The logic 111 identifies one of the data streams as having a sampling rate lower than the other. The logic 111 fills in data points of the data stream having the lower sampling rate using interpolation. Generally, interpolation involves identifying a trend in existing data points. The logic 111 generates additional data points between the existing data points along a curve corresponding to the identified trend. The number of inserted additional data points is based on the up-sampling needed to result in two data streams having a uniform sampling rate. In one embodiment, the logic 111 performs a process including sequentially selecting each data stream among the multiple time-series data streams. For each data stream, the logic 111 identifies its sampling rate. The logic 111 identifies the data stream having the highest sampling rate and up-samples the remaining data streams, using interpolation, to the highest sampling rate. According to one embodiment, the sampling interpolation logic 111 interpolates values in the time-series data streams using cubic spline interpolation. In one or more alternative embodiments, the sampling interpolation logic 111 interpolates values using: linear interpolation, in which a new value is the mean of the previous value and the next value; exponentially weighted moving averages; inverse Lagrangian interpolation; or Kalman filters. In yet another embodiment, the sampling interpolation logic 111 generates a uniform sampling rate among the different data streams in a down-sampling process.

The time-series data processing device 110 includes synchronization logic 112 to synchronize the separate streams of time-series data. In one embodiment, the synchronization logic 112 synchronizes the separate streams of time-series data using the time-stamps of the different streams.

The time-series data processing device 110 includes a machine learning engine 113 that uses data correlation models to generate a set 118 of parallel time-series data having imputed data values in the place of interpolated data values. The machine learning engine 113 divides a data set 114 including interpolation-generated data into two subsets 115 and 116 of data. In one embodiment, each subset corresponds to a different period of time of the time-series data. For example, subset 115 may be a set of data including data from all the parallel data streams between a time T₀ and Tᵢ, later than T₀. The subset 116 may be a set of data including data from all the parallel data streams between the time Tᵢ₊₁ and a time T₁, later than Tᵢ₊₁. In one embodiment, the subsets 115 and 116 are of equal lengths.

The machine learning engine 113 trains a first data correlation model 117 using the subset 115. In one embodiment, the data correlation model 117 is a multivariate state estimation technique (MSET) model. In alternative embodiments, the data correlation model 117 is any non-linear, non-parametric pattern recognition model, including neural networks, support vector machine (SVM) models, auto-associative kernel regression models, MSET1-based models, and MSET2-based models. Training the data correlation model 117 results in a trained model based on correlations between (a) different data points in different data streams at a same point in time, and (b) different data points in a same stream at different points in time.

The machine learning engine 113 performs an iterative process for (a) training a data correlation model using one of the subsets 115 and 116, (b) applying a trained data correlation model to the other one of the subsets 115 and 116, and (c) replacing interpolated values in a subset 115 or 116 with imputed estimated values generated by the trained model. The machine learning engine 113 concatenates the modified subsets 115, 116, including the imputed estimated values, to generate an imputation-based time-series data set 118.

A time-series data utilization layer 140 receives as an input the imputation-based time-series data set 118. One or more data utilization processes 141 of the time-series data utilization layer 140 perform one or more operations on the data set 118. Examples of data-utilization processes 141 include data analytics 142, a system control process 143, and displaying data on a graphical user interface (GUI) 144. For example, data analytics 142 may include processes to identify anomalies in a system or predict future states of the system, such as a failure of one or more components in the system. Examples of system control processes 143 include operations to turn on/turn off devices, or adjust power levels, temperature levels, flow rates, or positions of devices in a system. For example, the imputation-based time-series data set 118 may identify a particular device that has completed one stage of a monitored process, causing the system control process 143 to turn off one device and turn on another device that controls a next stage in the monitored process.

In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 5, titled “Computer Networks and Cloud Networks.”

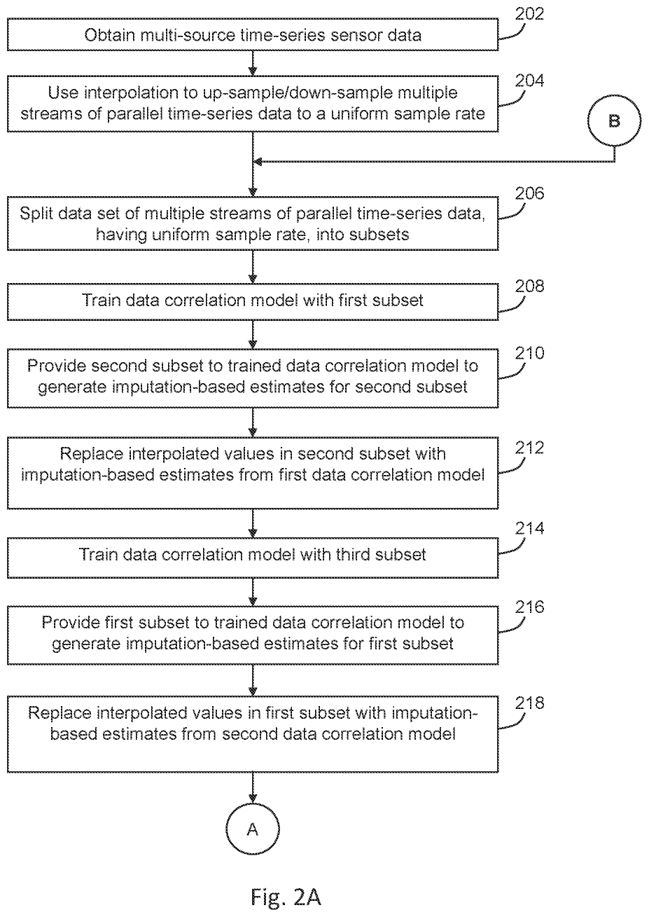

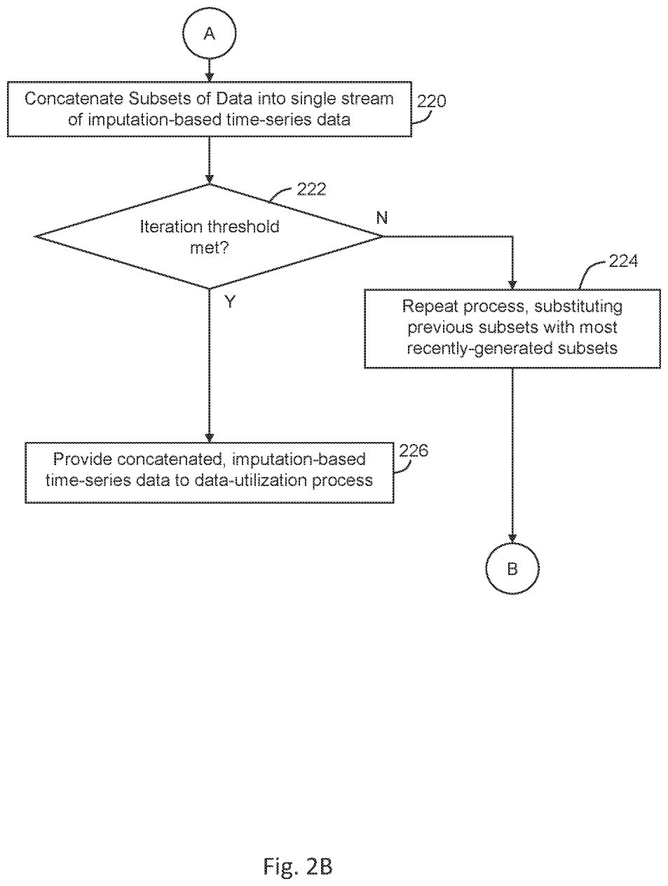

In one or more embodiments, a time-series data processing device 110 refers to hardware and/or software configured to perform operations described herein for (a) receiving a set of parallel time-series data, (b) performing pre-processing to up-sample/down-sample the data and synchronize the data, and (c) perform iterative training and application of a data correlation model to replace interpolated values in the time-series data with imputed estimated values generated by the data correlation model. Examples of operations for generating imputation-based time-series data are described below with reference to FIGS. 2A and 2B.

In an embodiment, the time-series data processing device 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In one or more embodiments, interface 145 refers to hardware and/or software configured to facilitate communications between a user and one or more data-utilization processes 141. Interface 145 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 145 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 145 is specified in one or more other languages, such as Java, C, or C++.

### 3. Generating Imputation-Based Time-Series Data

FIGS. 2A and 2B illustrate an example set of operations for generating imputation-based time-series data in accordance with one or more embodiments. One or more operations illustrated in FIGS. 2A and 2B may be modified, rearranged, or omitted all together. Accordingly, the particular sequence of operations illustrated in FIGS. 2A and 2B should not be construed as limiting the scope of one or more embodiments.

A system obtains time-series data from multiple data sources (Operation 202). For example, the system may receive sensor data from multiple sensors in a system. The system receives the sensor data as a set of parallel time-series data. The streams of parallel time-series data have different sampling rates and lack synchronization. For example, even if two monitored devices are configured to be synchronized to a same clock, variations in system clocks result in portions of the data streams being un-synchronized.

The system uses interpolation to generate a set of uniformly-sampled streams of parallel time-series data (Operation 204). In one embodiment, the system identifies the sampling rate of each stream of time-series data. The system up-samples each data stream having a sampling rate less than the stream having the highest sampling rate. The system generates data points in the data stream having a lower sampling rates using interpolation. In another embodiment, the system identifies time stamps of every data point in all of the streams of data. The system identifies the smallest gap between any two points of data and up-samples every data stream to a sampling rate corresponding to the smallest gap.

Interpolating data points may include identifying a data trend in existing data and inserting additional data points into the data stream between the existing data points along a curve corresponding to the identified trend. The number of inserted additional data points is based on the up-sampling needed to result in the uniform sampling rate among all the data streams. In one embodiment, the system interpolates values in the time-series data streams using cubic spline interpolation. In one or more alternative embodiments, the system interpolates values using: linear interpolation, in which a new value is the mean of the previous value and the next value; exponentially weighted moving averages; inverse Lagrangian interpolation; or Kalman filters. The system synchronizes the separate streams of time-series data using the time-stamps of the different streams. The synchronization may occur prior to, subsequent to, or during the up-sampling/down-sampling of the data streams. The result of the interpolation and synchronization is a set of time-series data made up of parallel streams of synchronized and uniformly-sampled time-series data. In one embodiment, the system generates metadata for each data stream to track which data points were generated as a result of original sensor data and which data points were generated as a result of interpolation. As the system performs an iterative process of replacing the interpolated values with imputation-based values and updating the imputation-based values with new imputation-based values, the system may refer to the metadata to determine which values in the data streams should be replaced and updated.

The system divides the set of data, including the added interpolated values, into subsets (Operation 206). In one embodiment, the system divides the time-series data at a particular point in time in the time-series. For example, one subset may include the parallel data streams between a time T₀ and Tᵢ, later than T₀. Another subset may include the parallel data streams between the time Tᵢ₊₁ and a time T₁, later than Tᵢ₊₁. In an embodiment in which the time-series data is sensor data, each of the subsets includes time-series data from each sensor. For example, if the time-series data includes data collected over a period of time from ten sensors, the first subset may include the sensor data over a first period of time from the ten sensors, and the second subset may include the sensor data over a second period of time, after the first period of time, from the same ten sensors. While an embodiment is described in which two subsets of data are generated, embodiments include any number of subsets of data.

The system trains a data correlation model using a first subset of data including interpolated values (Operation 208). Training the data correlation model results in a trained model based on correlations between (a) different data points in different data streams at a same point in time, and (b) different data points in a same stream at different points in time. In one embodiment, the data correlation model is a multivariate state estimation technique (MSET) model. The MSET model analyzes the values for the data points in the first subset to identify correlations among the data points of the data streams in the first subset. In a typical application of an MSET model, a data set is provided to the model as an optimal subset of data that best characterizes operation of inter-relationships among data points. Here, the first subset is instead a preliminary training set in an iterative training and updating process. The data correlation model may be any non-linear, non-parametric pattern recognition model, including a neural network, a support vector machine (SVM) model, an auto-associative kernel regression (AAKR) model, an MSET1-based model, and an MSET2-based model.

The system applies the trained data correlation model to the second subset to generate estimated expected values for the second subset (Operation 210). The estimated expected values are imputed values based on correlations among the data points in the first subset. In other words, the estimated expected values are based on identified correlations among data points in different data streams instead of based on interpolating values from surrounding data points in the same data stream.

The system replaces the interpolated values in the second data set with the corresponding estimated expected values generated by the data correlation model (Operation 212). In other words, although the data correlation model is initially trained based on an interpolation-based data set, the data correlation model generates expected values based on imputation. Accordingly, replacing the interpolation-based data points in the second data set with imputation-based data points results in a third, imputation-based subset of data. In one embodiment, the system identifies which data values are interpolated values based on metadata provided to the system with the data subsets. The metadata may track which data points in the data subsets are interpolated values and which correspond to original data values received from data sources.

The system trains another data correlation model using the third subset (Operation 214). For example, in the embodiment in which the data correlation model is an MSET model, the system trains a first MSET model using the first subset of data. The system then trains a second MSET model using the third subset of data, corresponding to the second subset of data having interpolated values replaced with imputed values.

The system applies the second trained model to the first subset of data to generate estimated expected values for the first subset of data (Operation 216). The system replaces the interpolated values in the first subset of data with corresponding imputed values generated by the second data correlation model, resulting in a fourth subset of data.

The system concatenates the third subset of data and the fourth subset of data (Operation 220). The resulting data set corresponds to the initial data set of time-series data made up of parallel streams of synchronized and uniformly-sampled time-series data, except the interpolated values of the initial data set have been replaced by imputed values generated by the data correlation models.

The system determines whether in iteration threshold has been met (Operation 222). In one embodiment, the iteration threshold is a number of times the process of (a) splitting the data set, (b) training data correlation models for each subset, (c) providing the subsets to the trained data correlation models, and (d) replacing the interpolated values with imputed values, has been performed. In an alternative embodiment, the system determines whether the iteration threshold has been met prior to concatenating the third subset and the fourth subset.

In one embodiment, the iteration threshold is a number of iterations between three (3) and five (5). For example, a system may determine that iteratively training the data correlation models and providing the subsets of data to the data correlation models three times results in an accuracy in the imputed data within 1%. The system may further determine that continuing the iterative process consumes system resources without achieving substantial accuracy improvements. Accordingly, the system may set the iteration threshold to three (3) iterations. Alternatively, the system may require greater accuracy and may determine that additional iterations do not overly tax the system components. Accordingly, the system may set the iteration threshold to five (5). In an alternative embodiment, the iteration threshold is a measure of the accuracy of the imputed values. For example, the system may set the iteration “improvement” threshold to 3%, indicating that once it has determined that the imputed values are, on average, improving by less than 3% for the present iteration compared with the previous iteration, the system stops the iterative process. The system may estimate the accuracy by applying the data correlation models to known sets of data to test the data correlation models.

If the system determines that the iteration “improvement” threshold has not been met, the system repeats the process of (a) splitting the data set, (b) training data correlation models for each subset of data, (c) applying the data correlation models to the subsets of data, and (d) updating the imputed values in the subsets until the iteration threshold is met (Operation 224). In one embodiment, the system keeps track of which values in the initial data set were generated by interpolation-based up-sampling. In each iteration, the system updates only the imputed values, which were originally interpolation-generated values, while leaving unchanged the measured data values. In other words, in each iteration of the above process, the values that were obtained directly from sensor data remain the same and the values that were initially generated by interpolation-based up-sampling are repeatedly updated by applying newly-trained data correlation models to the updated data sets (in which the interpolated data points have been replaced by imputed data points).

If the system determines that the iteration threshold has been met, the system provides the concatenated, imputation-based time-series data to one or more data-utilization processes (Operation 226). Examples of data-utilization processes include fault-detection analysis, system state predictions, and data displayed on a GUI.

In one or more embodiments, the initially-received, unsynchronized, non-uniformly sampled time-series data is streaming time-series data. The data may be processed with the iterative process described above and output to a system or process that relies on real-time streaming data. In an alternative embodiment, the initial set of data is static data, such as data stored in a database. The data may be divided into predefined segments and processed with the iterative process. The resulting imputation-based data may be used to recognize historical anomalies in a system or prognosticate a future state of the system, for example.

### 4. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

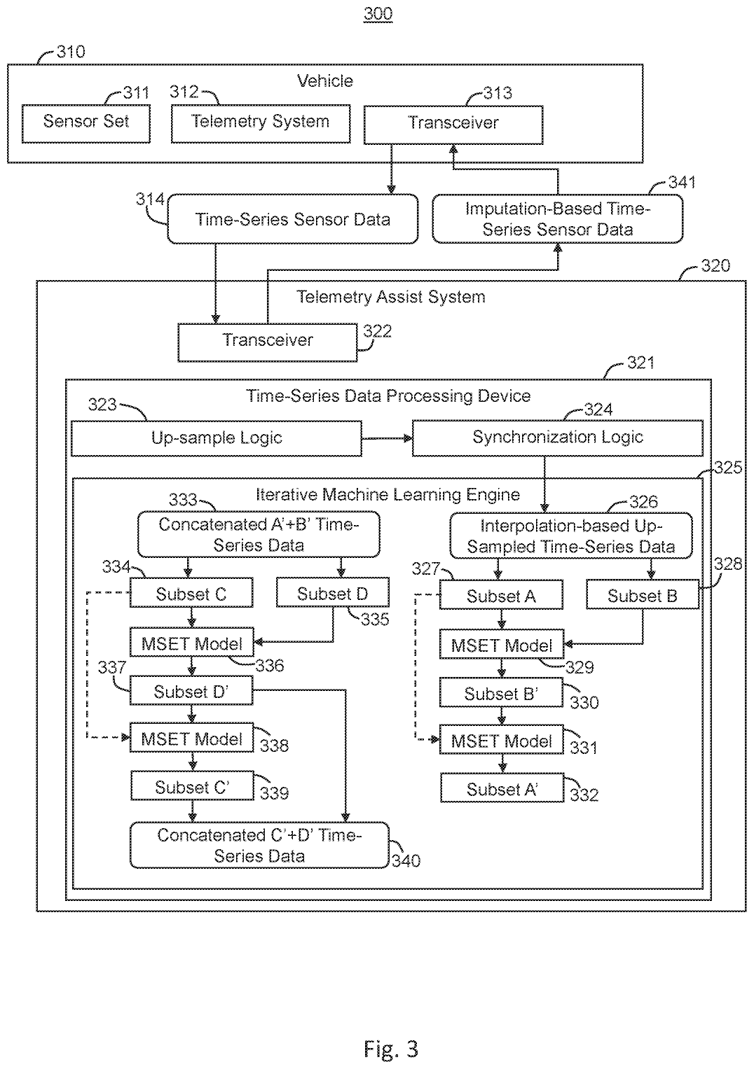

FIG. 3 illustrates a system 300 in which time-series data, received in real-time, is converted into imputation-based time series data in real-time to assist a vehicle to obtain accurate telemetry data.

The system includes a vehicle 310 and a telemetry assist system 320. The vehicle 310 includes a set of sensors 311 measuring characteristics of the vehicle 310, such as telemetry characteristics. The set of sensors 311 generates a set of parallel time-series sensor data 314. The time-series sensor data 314 includes multiple streams of time-series data corresponding to the multiple sensors. The multiple streams of sensor data have different sampling rates and may be unsynchronized relative to each other.

The vehicle 310 transmits, via the transceiver 313, time-series sensor data 314. In one embodiment, the vehicle continually transmits the time-series data 314, and the telemetry-assist system 320 divides the received data into predetermined segments based on the time-stamps in the time-series data. For example, the telemetry assist system 320 may divide received time-series sensor data into segments of one minute. The time-series data processing device 321 may process the time series data in the one-minute segments. Alternatively, the telemetry assist system 320 may divide received time-series sensor data into segments of one minute, and the time-series data processing device 321 may combine a most-recently received one-minute segment of data with a previously-received nine minutes of data to perform data processing. In yet another embodiment, the vehicle 310 transmits the time-series data 314 in batches of predetermined time intervals, such as ten seconds, one minute, or ten minutes.

In an embodiment in which the telemetry system 312 of the vehicle 310 relies on the time-series sensor data 314 in real-time, the vehicle may stream the time-series sensor data 314 in segments of milliseconds or less, and the time-series processing device 321 may continually generate batches that include (a) the most recently-received segment of data from the vehicle 310, and (b) a predetermined number of previously-received segments of data from the vehicle to process the time-series data from the vehicle 310. For example, the telemetry assist system 320 may process a batch including: (a) recently-received segment E, and (b) previously-received segments A-D. Upon receiving the next segment F from the vehicle 310, the telemetry assist system may process a batch including: (a) segment F, and (b) segments B-E.

The telemetry-coordination system 320 receives the time-series data 314 via a transceiver 322, such as an antenna. The telemetry-coordination system 330 includes a time-series data processing device 331. In one embodiment, the time-series data processing device 331 is a graphics processing unit (GPU). The time-series data processing device 331 includes up-sample logic 323 and synchronization logic 324. The time-series sensor data 314 may include parallel time-series data from, for example, ten sensors. The data stream of a first sensor among the ten sensors has a higher sampling rate than the other nine data streams. The up-sample logic 323 interpolates data points for the nine sensors having lower sampling rates to generate a data set of ten time-series sensor data streams having uniform sampling rates. In one embodiment, the interpolation-based up-sampling process is cubic spline interpolation.

The synchronization logic 324 synchronizes the ten time-series sensor data streams using time-stamp data in the sensor data streams. As a result of the synchronization, the synchronization logic 324 generates a data set of ten synchronized time-series sensor data streams having uniform sampling rates. The data set may further include metadata identifying the data points in the sensor data streams that were generated as a result of the interpolation-based up-sampling.

An iterative machine learning engine 325 receives the data set 326 generated by processing the time-series sensor data 314 through the up-sampling logic 323 and the synchronization logic 324. The machine learning engine 325 divides the data set 326 into two subsets 327 and 328 of equal size. Each subset 327 and 328 is made up of the ten sensor data streams over different periods of time. The subset A 327 includes the sensor data of the ten sensor data streams, and the interpolated data points, from a starting time T₀ to a time Tᵢ, later than T₀. The subset B 328 includes the sensor data of the ten sensor data streams, and the interpolated data points, from the time Tᵢ₊₁ to a time T₁, later than Tᵢ₊₁.

The machine learning engine 325 trains a first MSET model 329 using the data subset A 327 to identify the correlations between the sensor data streams in the subset A 327. The machine learning engine 325 applies the first trained MSET model 329 to the subset B 328 to generate estimated values for the subset B 328, based on the correlations learned while training the first MSET model 329. The machine learning engine 325 replaces the interpolated values in subset B 328 with the estimated values generated by the MSET model 329 to generate subset B′ 330. In one embodiment, the machine learning engine 325 identifies which values are interpolated values based on the metadata associated with the data streams in the subset B 328.

The machine learning engine 325 trains a second MSET model 331 using the data subset B′ 330 to identify the correlations between the sensor data streams in the subset B′ 330. The machine learning engine 325 applies the second trained MSET model 331 to the subset A 327 to generate estimated values for the subset A 327, based on the correlations learned while training the second MSET model 331. The machine learning engine 325 replaces the interpolated values in subset A 327 with the estimated values generated by the MSET model 331 to generate subset A′ 332.

The machine learning engine 325 concatenates the subsets A′ and B′ 332 and 330 to generate a concatenated time-series data set 333. The time-series data set 333 corresponds to the interpolation-based up-sampled time-series data 326 in which the interpolated values have been replaced with imputed values from the MSET models 329 and 331. The iterative machine learning engine 325 determines whether an iteration threshold is met. For example, the machine learning engine may determine whether the process of training MSET models and replacing the previously-interpolated data points has been performed a predetermined number of times. If not, the machine learning engine 325 repeats the process.

The machine learning engine 325 divides the data set 333 into two subsets 334 and 335 of equal size. Each subset 334 and 335 is made up of the ten sensor data streams over the periods of time T₀ to Tᵢ and Tᵢ₊₁ to T₁, respectively.

The machine learning engine 325 trains a third MSET model 336 using the data subset C 334 to identify the correlations between the sensor data streams in the subset C 334. The machine learning engine 325 applies the third MSET model 336 to the subset D 335 to generate estimated values for the subset D 335, based on the correlations learned while training the third MSET model 336. The machine learning engine 325 replaces the imputed values of subset D 335, which had previously been interpolated values in the data set 326, with the estimated values generated by the MSET model 336 to generate subset D′ 337. While the embodiment illustrated in FIG. 3 shows the MSET model 336 being trained by the subset C 334, embodiments include training the MSET model 336 with subset D 335 and applying the MSET model 336 to subset C 334. In other words, in each iteration of the process of training and applying MSET models to the subsets, either data subset may be used to train an initial MSET model, and the other data subset is used to train a subsequent MSET model.

The machine learning engine 325 trains a fourth MSET model 338 using the data subset D′ 337 to identify the correlations between the sensor data streams in the subset D′ 337. The machine learning engine 325 applies the fourth trained MSET model 338 to the subset C 334 to generate estimated values for the subset C 334, based on the correlations learned while training the fourth MSET model 338. The machine learning engine 325 replaces the imputed values of subset C 334, which had previously been interpolated values in the data set 326, with the estimated values generated by the MSET model 338 to generate subset C′ 339. With each iteration of: (a) training an MSET model using one subset of data, (b) applying the MSET model to another subset of data, (c) replacing imputed values, which were previously interpolated values, with new imputed values, the imputed values increase in accuracy. In the first iteration, the system trains the data correlation models using data sets having interpolated values. The resulting modified subsets, in which the interpolated values are replaced by imputed values, are more accurate than the initial training subsets. In the next iteration, in which the system trains the data correlation models using subsets of data with imputed values in place of interpolated values, the resulting modified subsets of data are more accurate than the initial modified subsets. The next iteration results in yet more accurate sets of data. In one or more embodiments, measurable improvements in data accuracy occur until up to around five (5) iterations have been performed.

The machine learning engine 325 concatenates the subsets C′ and D′ 339 and 337 to generate a concatenated time-series data set 340. Upon determining that the iteration threshold is met, the telemetry assist system 320 transmits the concatenated time-series data 340 as imputation-based time series data 341 to the vehicle 310 via the transceiver 322. The time series data 341 includes the ten parallel streams of sensor data having uniform sampling rates. The ten parallel streams of sensor data include imputed values in the place of previously-interpolated values. In one or more embodiments, the telemetry system 312 of the vehicle 310 utilizes the time series data 341 to: detect anomalies in the sensor set 311, predict a state of the vehicle 310 or one or more monitored systems in the vehicle 310, or adjust one or more telemetric characteristics of the vehicle 310.

### 5. Computer Networks and Cloud Networks

In one or more embodiments, the system 100 is embodied in a computer network. The computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. For example, a client may access the data-utilization processes 141 of the time-series data utilization layer 140 via the interface 145. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 6. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

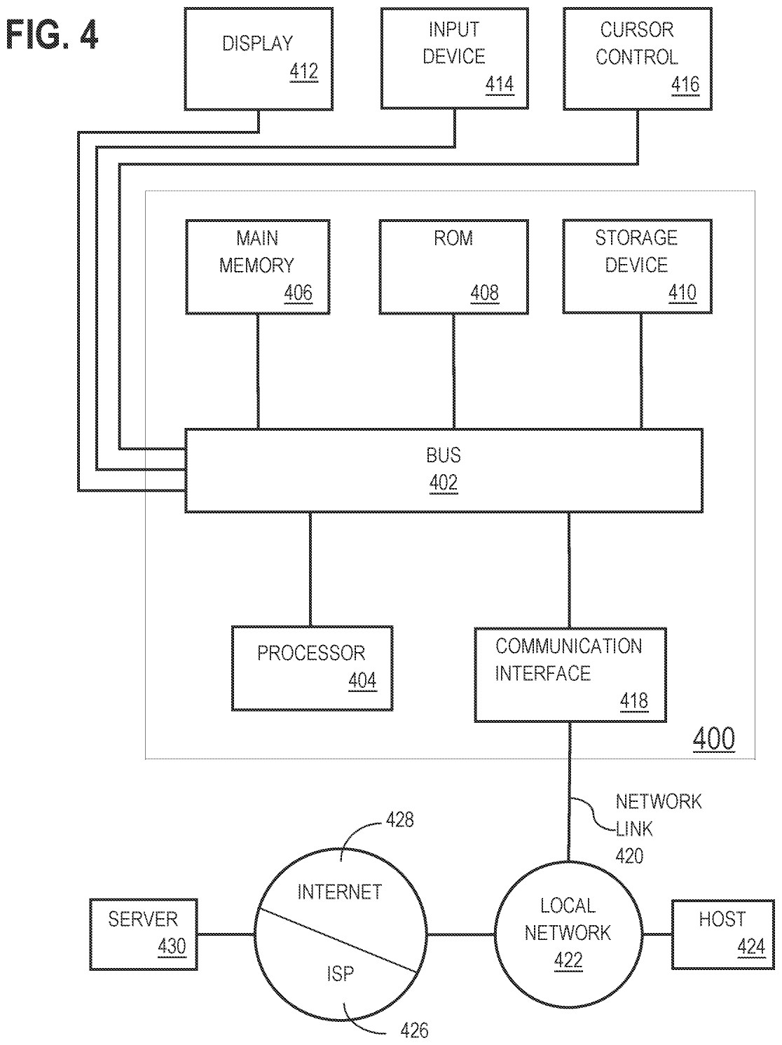

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk or optical disk, is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by one or more hardware processors, causes performance of operations comprising:
identifying a dataset comprising a plurality of data points;
wherein each data point in the plurality of data points comprises a plurality of values;
partitioning the dataset into at least a first subset of data points and a second subset of data points, wherein the first subset of data points comprises a first data point and the second subset of data points comprises a second data point;
wherein a first plurality of values, corresponding to the first data point, comprises (a) a first set of sensor-detected values and (b) a first set of interpolated values;
wherein a second plurality of values, corresponding to a second data point, comprises (a) a second set of sensor-detected values and (b) a second set of interpolated values;
updating interpolated values in the first subset of data points and the second subset of data points at least by:
(a) training a first data correlation model based on the first subset of data points;
(b) applying the first data correlation model to at least a portion of the second subset of data points to revise one or more interpolated values of the second subset of data points to generate a revised second subset of data points;
(c) training a second data correlation model based on the revised second subset of data points;
(d) applying the second data correlation model to at least a portion of the first subset of data points to revise one or more interpolated values of the first subset of data points to generate a revised first subset of data points;
concatenating the revised first subset of data points and the revised second subset of data points to generate a revised plurality of data points.

2. The medium of claim 1, wherein applying the first data correlation model to at least the portion of the second subset of data points to revise the one or more interpolated values of the second subset of data points comprises revising at least one of the second set of interpolated values comprised in the second data point.

3. The medium of claim 1, wherein the operations further comprise:
(e) training a third data correlation model based on the revised first subset of data points;
(b) applying the third data correlation model to at least a portion of the revised second subset of data points to revise the one or more interpolated values of the second subset of data points to further revise the revised second subset of data points.

4. The medium of claim 1, wherein the operations further comprise:
identifying a process utilizing the plurality of data points to perform one or more operations; and
providing the revised plurality of data points to the process, instead of the plurality of data points, to perform the one or more operations.

5. The medium of claim 1, wherein the operations further comprise:
(e) subsequent to revising the one or more interpolated values of the first subset of data points and the one or more interpolated values of the second subset of data points, repeating operations (a)-(d), replacing the first subset with the revised first subset, and replacing the second subset with the revised second subset.

6. The medium of claim 1, wherein the dataset comprises a plurality of parallel time-series sensor data signals,
wherein partitioning the dataset into at least a first subset of data points and a second subset of data points comprises dividing the dataset into the first subset of data points generated prior to a particular time and the second subset of data points generated at, or after, the particular time.

7. The medium of claim 1, wherein the first data correlation model and the second data correlation model are multivariate state estimation technique (MSET) models.

8. The medium of claim 1, wherein the first set of interpolated values and the second set of interpolated values are generated by up-sampling data streams from one or more sensors.

9. A method, comprising:
identifying a dataset comprising a plurality of data points;
wherein each data point in the plurality of data points comprises a plurality of values;
partitioning the dataset into at least a first subset of data points and a second subset of data points, wherein the first subset of data points comprises a first data point and the second subset of data points comprises a second data point;
wherein a first plurality of values, corresponding to the first data point, comprises (a) a first set of sensor-detected values and (b) a first set of interpolated values;
wherein a second plurality of values, corresponding to a second data point, comprises (a) a second set of sensor-detected values and (b) a second set of interpolated values;
updating interpolated values in the first subset of data points and the second subset of data points at least by:
(a) training a first data correlation model based on the first subset of data points;
(b) applying the first data correlation model to at least a portion of the second subset of data points to revise one or more interpolated values of the second subset of data points to generate a revised second subset of data points;
(c) training a second data correlation model based on the revised second subset of data points;
(d) applying the second data correlation model to at least a portion of the first subset of data points to revise one or more interpolated values of the first subset of data points to generate a revised first subset of data points;
concatenating the revised first subset of data points and the revised second subset of data points to generate a revised plurality of data points.

10. The method of claim 9, wherein applying the first data correlation model to at least the portion of the second subset of data points to revise the one or more interpolated values of the second subset of data points comprises revising at least one of the second set of interpolated values comprised in the second data point.

11. The method of claim 9, further comprising:
(e) training a third data correlation model based on the revised first subset of data points;
(b) applying the third data correlation model to at least a portion of the revised second subset of data points to revise the one or more interpolated values of the second subset of data points to further revise the revised second subset of data points.

12. The method of claim 9, further comprising:
identifying a process utilizing the plurality of data points to perform one or more operations; and
providing the revised plurality of data points to the process, instead of the plurality of data points, to perform the one or more operations.

13. The method of claim 9, further comprising:
(e) subsequent to revising the one or more interpolated values of the first subset of data points and the one or more interpolated values of the second subset of data points, repeating operations (a)-(d), replacing the first subset with the revised first subset, and replacing the second subset with the revised second subset.

14. The method of claim 9, wherein the dataset comprises a plurality of parallel time-series sensor data signals,
wherein partitioning the dataset into at least a first subset of data points and a second subset of data points comprises dividing the dataset into the first subset of data points generated prior to a particular time and the second subset of data points generated at, or after, the particular time.

15. The method of claim 9, wherein the first data correlation model and the second data correlation model are multivariate state estimation technique (MSET) models.

16. The method of claim 9, wherein the first set of interpolated values and the second set of interpolated values are generated by up-sampling data streams from one or more sensors.

17. A system, comprising:
one or more processors; and
memory storing instructions that, when executed by the one or more processors, cause the system to perform:
identifying a dataset comprising a plurality of data points;
wherein each data point in the plurality of data points comprises a plurality of values;
partitioning the dataset into at least a first subset of data points and a second subset of data points, wherein the first subset of data points comprises a first data point and the second subset of data points comprises a second data point;
wherein a first plurality of values, corresponding to the first data point, comprises (a) a first set of sensor-detected values and (b) a first set of interpolated values;
wherein a second plurality of values, corresponding to a second data point, comprises (a) a second set of sensor-detected values and (b) a second set of interpolated values;
updating interpolated values in the first subset of data points and the second subset of data points at least by:
(a) training a first data correlation model based on the first subset of data points;
(b) applying the first data correlation model to at least a portion of the second subset of data points to revise one or more interpolated values of the second subset of data points to generate a revised second subset of data points;
(c) training a second data correlation model based on the revised second subset of data points;
(d) applying the second data correlation model to at least a portion of the first subset of data points to revise one or more interpolated values of the first subset of data points to generate a revised first subset of data points;
concatenating the revised first subset of data points and the revised second subset of data points to generate a revised plurality of data points.

18. The system of claim 17, wherein applying the first data correlation model to at least the portion of the second subset of data points to revise the one or more interpolated values of the second subset of data points comprises revising at least one of the second set of interpolated values comprised in the second data point.

19. The system of claim 17, wherein the instructions cause the system to further perform:
(e) training a third data correlation model based on the revised first subset of data points;
(b) applying the third data correlation model to at least a portion of the revised second subset of data points to revise the one or more interpolated values of the second subset of data points to further revise the revised second subset of data points.

20. The system of claim 17, wherein the instructions cause the system to further perform:
identifying a process utilizing the plurality of data points to perform one or more operations; and
providing the revised plurality of data points to the process, instead of the plurality of data points, to perform the one or more operations.
